(19) United States
(12) Patent Application Publication
(10) Pub. No.: US 2021/0173231 A1
(43) Pub. Date: Jun. 10, 2021

(54) Auxiliary Lens Attachments for Eyeglasses

(71) Applicant: Chadwick Optical, Inc., Harleysville, PA (US)

(72) Inventor: Charlie Saccarelli, Harleysville, PA (US)

(21) Appl. No.: 16/709,918

(22) Filed: Dec. 10, 2019

(51) Int. Cl. G02C 9/00

(52) U.S. Cl. CPC G02C 9/00; G02C 2200/02

(57) ABSTRACT

A system of attaching auxiliary lenses to a pair of eyeglasses. One auxiliary lens can have one, two, three or more magnets embedded therein, and one of the eyeglasses in the pair of eyeglasses could have a corresponding one, two, three or more magnets embedded therein which would have their polarity configured such that the auxiliary lens would fit over and remain attached to the eyeglass.

### BACKGROUND OF THE INVENTION

### Field of the Invention

The present general inventive concept is directed to a method and apparatus for auxiliary lenses which can be easily attached and removed to a pair of eyeglasses.

### Description of the Related Art

Auxiliary lenses can be placed over (or behind) eyeglasses and can serve numerous functions (e.g., magnification, etc.) U.S. Pat. No. 7,600,870 to Zelazowski teaches a method of mounting the auxiliary lenses which use magnets.

### SUMMARY OF THE INVENTION

It is an aspect of the present invention to provide

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing showing an auxiliary lens attached to a front of an eyeglass in a pair of eyeglasses, according to an embodiment;

FIG. 2 is a drawing showing a pair of eyeglasses with an unattached attachable auxiliary lens, according to an embodiment;

FIG. 3 is a front view showing a pair of eyeglasses with an attached auxiliary lens, according to an embodiment;

FIG. 4 is a cross section view from the view shown in FIG. 3, according to an embodiment;

FIG. 5 is a front view showing a pair of eyeglasses attached to another auxiliary lens, according to an embodiment;

FIG. 6 is a front view of showing a pair of eyeglasses attached to a further auxiliary lens, according to an embodiment;

FIG. 7 is a front view showing a pair of eyeglasses attached to an additional auxiliary lens, according to an embodiment;

FIG. 8 is a diagonal view showing an auxiliary lens attached behind an eyeglass in the pair of eyeglasses, according to an embodiment;

FIG. 9 is a diagonal view showing eyeglasses with an unattached attachable auxiliary lens, according to an embodiment; and

FIG. 10 is a drawing showing eyeglasses with two auxiliary lenses with magnets of opposite polarity, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

An auxiliary lens can be utilized over (or behind) a lens in an eyeglass (which would have two prescription lenses). The auxiliary lens could serve numerous purposes, such as magnification, shade, etc. The auxiliary lens will have at least two embedded magnets which will adhere to at least two corresponding embedded magnets in the prescription lens.

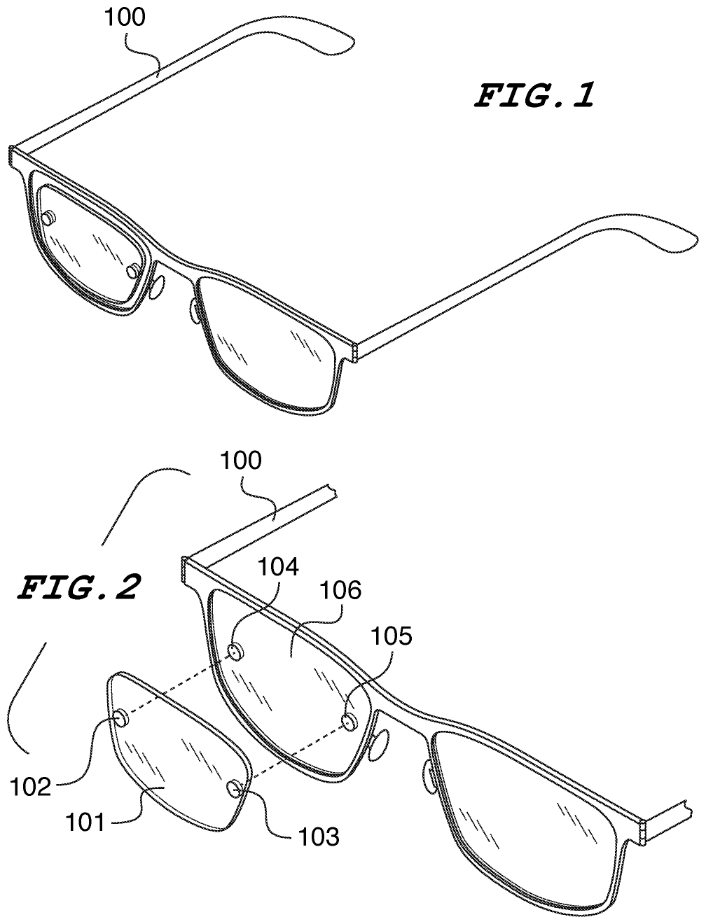

FIG. 1 is a drawing showing an auxiliary lens attached to a front of an eyeglass in a pair of eyeglasses, according to an embodiment.

A pair 100 of eyeglasses can be a standard pair which would typically have a pair of prescription lenses therein. One (or both) of the lenses would have embedded magnets. Shown is an auxiliary lens (also with two embedded magnets) attached to the prescription lens. Each magnet is attracted to is counterpart (based on their respective polarities) so that the auxiliary lens remains attached to the prescription lens. However, the auxiliary lens can easily be removed from the prescription lens by simple removing it manually. Some possible types of auxiliary lenses that would typically be mounted on the outside of a pair of eyeglasses (such as illustrated in FIG. 1) could be a magnification lens, a telescopic lens, a prism lens (for low vision), etc.

FIG. 2 is a drawing showing a pair of eyeglasses with an unattached attachable auxiliary lens, according to an embodiment.

Each lens (auxiliary, prescription, eyeglass, etc.) has a circular hole(s) drilled therein in order to snugly accommodate and fit each magnet. Each magnet can be made of steel or any other suitable material. Each embedded magnet(s) can be between 0.75 and 1.55 mm thick. The diameter of each magnet can be from 3/32 inch to 5/16^{th} inch. Note that each magnet (in both the auxiliary lens and the prescription lens) is positioned a uniform distance from a perimeter (more technically the closest point on the perimeter) of the respective lens. Note that typically each auxiliary lens would have the same number of magnets embedded therein as the eyeglass has embedded, and the positions would coincide so each pair of corresponding (counterpart) magnets would touch.

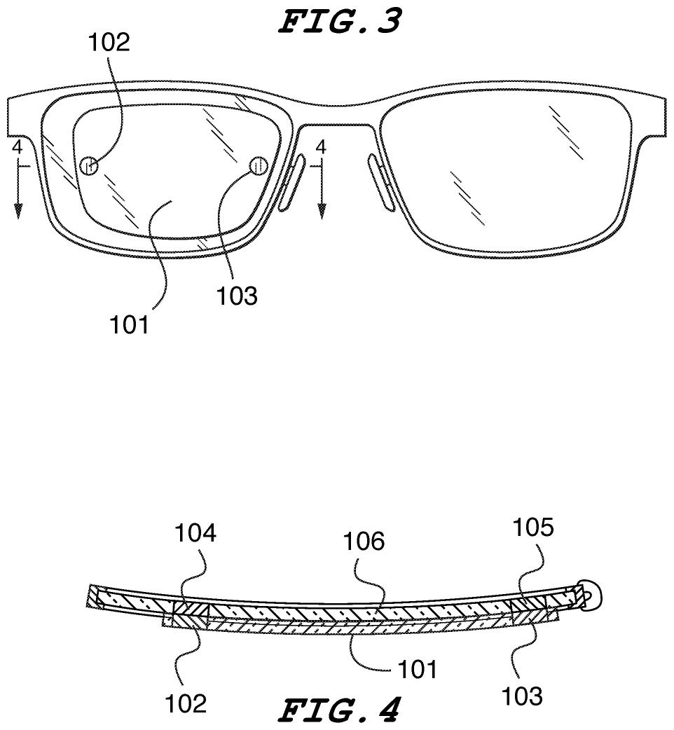

FIG. 3 is a front view showing a pair of eyeglasses with an attached auxiliary lens, according to an embodiment.

Shown in FIG. 3 is a cross section view labeled as ‘4’ which is illustrated in FIG. 4.

FIG. 4 is a cross section view from the view shown in FIG. 3, according to an embodiment.

As can be seen, the magnets 104, 105 in the prescription lens 106 are adjacent to their counterpart magnets 102, 103 in the auxiliary lens 101.

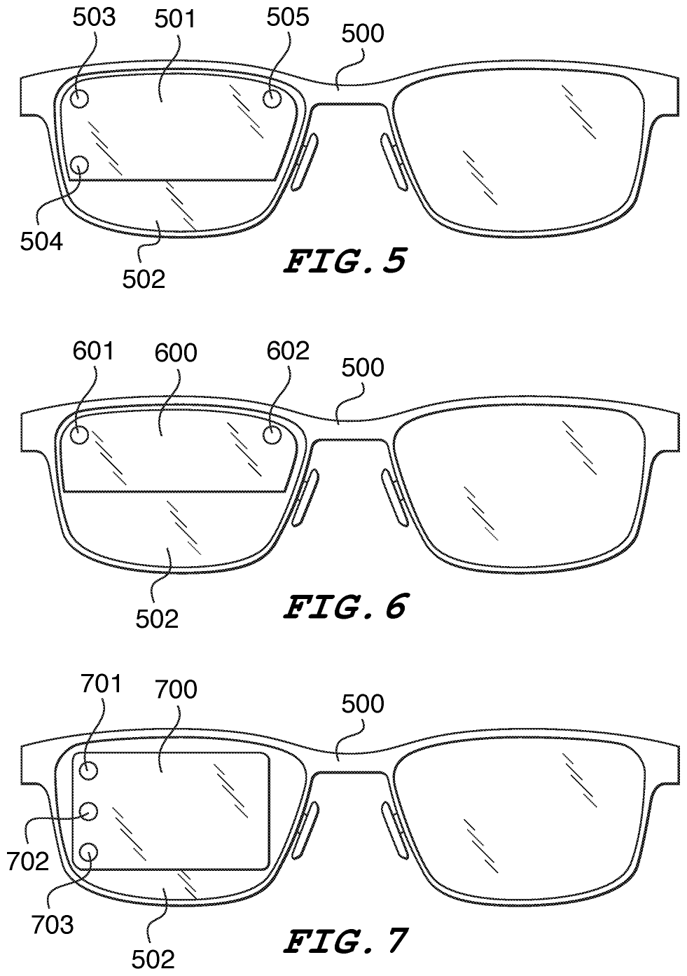

FIG. 5 is a front view showing a pair of eyeglasses attached to another auxiliary lens, according to an embodiment.

In another embodiment, an auxiliary lens 501 can be shaped with a flat bottom. There can also be three magnets 503, 504, 505 embedded into the auxiliary lens 501 and three counterpart magnets embedded into the prescription lens 502 in the pair of eyeglasses 500. Note that the distance between each magnet 503, 504, 505 in the auxiliary lens 501 is a constant distance from an edge (perimeter) of the auxiliary lens 501. Likewise, the three magnets in the prescription lens 502 all have a constant distance from an edge of the prescription lens 502.

FIG. 6 is a front view of showing a pair of eyeglasses attached to a further auxiliary lens, according to an embodiment.

The embodiment illustrated in FIG. 6 is similar to the embodiment illustrated in FIG. 5 but there are two magnets instead of three (as in FIG. 5).

FIG. 7 is a front view showing a pair of eyeglasses attached to an additional auxiliary lens, according to an embodiment.

The auxiliary lens 700 is rectangular shaped with three embedded magnets (aligned vertically) 701, 702, 703, all on the left side of the auxiliary lens 700. Having all of the magnets on the left side can have the advantage that this would reduce the interference with the wearer's vision since the right side (closer to the wearer's nose) has no magnets and is where the wearer's eye is more likely to be focused. User and Wearer are use synonymously herein.

While not pictured in FIG. 7, the right prescription lens can have three magnets embedded into its right side, and a second auxiliary lens

Note that all of the embodiments illustrated herein have an equal number of magnets embedded into the auxiliary lens and the prescription lens, and the counterpart magnets are located in an identical position in the respective lens so that the auxiliary lens would fit (via magnetic force) onto the prescription lens. In FIGS. 5-7 the magnets embedded the prescription lens are not visible but are present. Note that as shown, only one prescription lens (out of both prescription lenses) has an auxiliary lens, and only one prescription lens has the magnets embedded therein. In another embodiment, both prescription lenses would have magnets embedded therein.

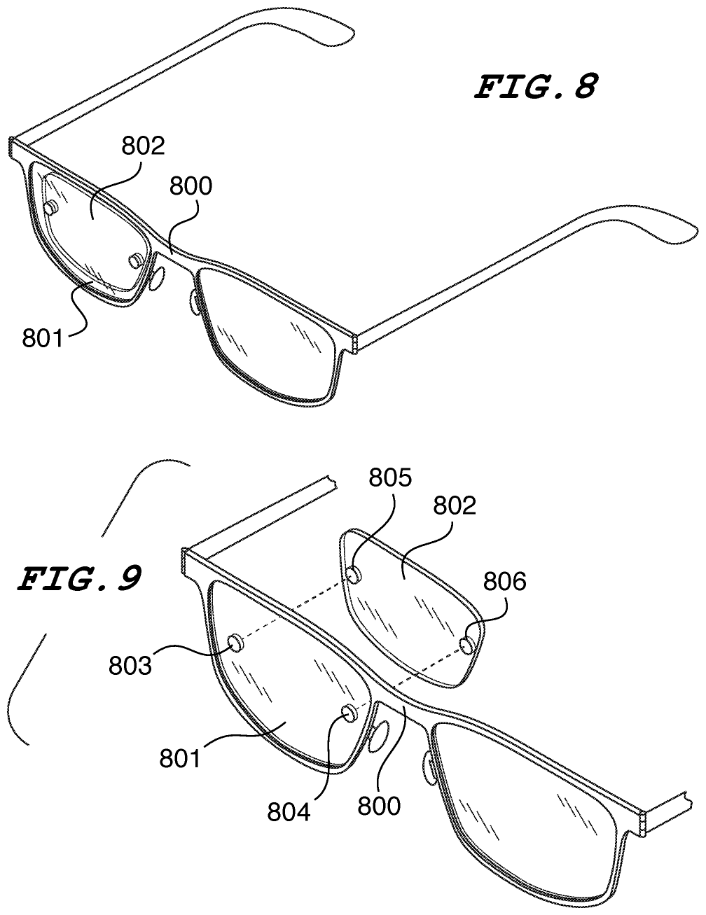

FIG. 8 is a diagonal view showing an auxiliary lens attached behind an eyeglass in the pair of eyeglasses, according to an embodiment. The auxiliary lens in this example 802 is positioned behind the eyeglass lens 801 on the pair of eyeglasses 800.

In some embodiments, the auxiliary lens can be attached to an eyeglass behind the eyeglass (instead of in front as illustrated in FIG. 2). Some possible types of auxiliary lenses that would typically be mounted inside would be prescription lenses (which would offer a wider field of view).

FIG. 9 is a diagonal view showing eyeglasses with an unattached attachable auxiliary lens which attached behind the pair of eyeglasses (the eyeglass lenses), according to an embodiment.

Note that the auxiliary lens 802 has two magnet 805, 806 which align (and attach) with magnets 803, 804 respectively, in the eyeglass lens 801.

Note that all magnets have a polarity and when a magnet is installed (embedded) inside the pair of eyeglasses, the corresponding (counterpart) magnet in the auxiliary lens should have the opposite polarity. In other words, for example in FIG. 2, both magnets embedded inside the eyeglass could have the north pole facing outward (away from the wearer) while the two magnets in the auxiliary lens would then have their south pole facing towards the eyeglasses (so all magnets would be attracted to their counterparts). During installation of the magnets, the technician should take care to ensure that the poles of the magnets are positioned properly so all magnets would be attracted to all of their counterparts. Each magnet and its counterpart would ultimately contact (touch) each other due to their mutual attraction (but of course the auxiliary lens can be easily removed by manually pulling it off of the eyeglass lens).

In an embodiment, auxiliary lenses can be intended for only particular eyes. For example, a first auxiliary lens could be intended only for use with a patient's left eye (and/or left lens in the pair of eyeglasses), while a second auxiliary lens (different from the first auxiliary lens) would be intended only for use with a patent's right eye (and/or right lens in the pair of eyeglasses). A selective application of the polarity of the magnets can be utilized to ensure that only the left auxiliary lens can attach to the left eyeglass lens and the right auxiliary lens can attach to the right eyeglass lens. For example, in FIG. 6, the left auxiliary lens (shown on the left of FIG. 6 although the opposite nomenclature can be used as well) has three embedded magnets which attach to two (but can be any other number such as three, etc.) corresponding magnets embedded in the left eyeglass lens. The three magnets embedded in the left eyeglass lens can all have their north pole facing outward (away from the user), and the three magnets embedded in the left auxiliary lens can all have their north pole facing outward (away from the user), thereby having a North/South pole attraction between each of the magnets therein. A right auxiliary lens (not shown in FIG. 6) can be a different kind of lens than the left auxiliary lens and is only intended to be placed over (or behind) the right eyeglass lens. Thus, the right eyeglass lens can have the opposite polarity as the left eyeglass lens, in other words the right eyeglass lens can have all three magnets with their south pole facing outward (away from the user). The right auxiliary lens can have its three magnets with the south pole facing outward (away from the user). As such, the right auxiliary lens would be repelled (instead of attracted) to being placed on the outside of the left eyeglass in the matching orientation, and the left auxiliary lens would be repelled (instead if attracted) to being placed on the outside of the right eyeglass lens. In this manner, the user can be provided with two separate auxiliary lenses and the user would not be able to get them mixed up since if they were placed on the wrong eyeglass lens it would not stick/stay.

Note a polarity configuration of any corresponding magnets (magnets in the auxiliary lens and eyeglass lens) can be any combination north/south or south/north so long as corresponding magnets that are intended to stick together all have opposite polarity.

Thus, in another embodiment, two auxiliary lenses can be provided to the user with incompatible polarities relative to the eyeglasses, thereby preventing the user from putting the wrong auxiliary lenses on the wrong eyeglass lenses. Table I below is an example of different embedded polarities that can be used in order to ensure the auxiliary lenses cannot get mixed up by the user. Note that all polarities shown (N=north, S=south) are all in either direction (towards the user or away from the user). Note that any number of magnets can be used (e.g., 1 to 4 or more)

TABLE I

| Magnet | Left | Left Auxiliary | Right | Right Auxiliary |
|---|---|---|---|---|
| # | Eyeglass | Lens | Eyeglass | Lens |
| 1 | N | N | S | S |
| 2 | N | N | S | S |
| 3 | N | N | S | S |

Table II below is another example of how polarities can be installed in order to prevent the right auxiliary lens from being attached to the left eyeglass lens and vice versa.

| Magnet | Left | Left Auxiliary | Right | Right Auxiliary |
|---|---|---|---|---|
| # | Eyeglass | Lens | Eyeglass | Lens |
| 1 | S | S | N | N |
| 2 | N | N | S | S |
| 3 | S | S | N | N |

It is noted that the examples in Tables I and II are merely examples and numerous other configurations can be utilized as well. The polarities of all magnets on the right eyeglass lens should all be opposite to the polarities of all magnets on the left eyeglass lens. In addition, the polarities of all magnets on the right auxiliary lens (which would be placed outside the right eyeglass lens) should be in the same orientation as the polarities of all magnets in the right eyeglass lens, and the polarities of all magnets on the left auxiliary lens (which would be placed outside the left eyeglass lens) should be in the same orientation as the polarities of all magnets in the left eyeglass lens. “same orientation” means that the north pole of one would be contacting the south pole of the other (or vice versa) when the proper auxiliary lens is placed over its respective eyeglass lens. The magnets can be located anywhere on the pair of eyeglasses/auxiliary lenses (e.g., on only one edge (see FIG. 7), on both edges (see FIG. 6), etc.)

Thus, in this manner, a user can be provided with a pair of eyeglasses and two auxiliary lenses (for example, see FIG. 6 but an auxiliary lens would be provided for the right eyeglass lens as well which may have a similar or identical appearance to the left auxiliary lens), and the user would not be able to accidently place the wrong auxiliary lens over a particular eyeglass lens. The left auxiliary lens and the right auxiliary lens could be different lenses or have different properties (e.g., different magnification, etc.) which can be specifically tailored for each user and it is important that the user make sure the proper auxiliary lens is attached to its intended eyeglass lens.

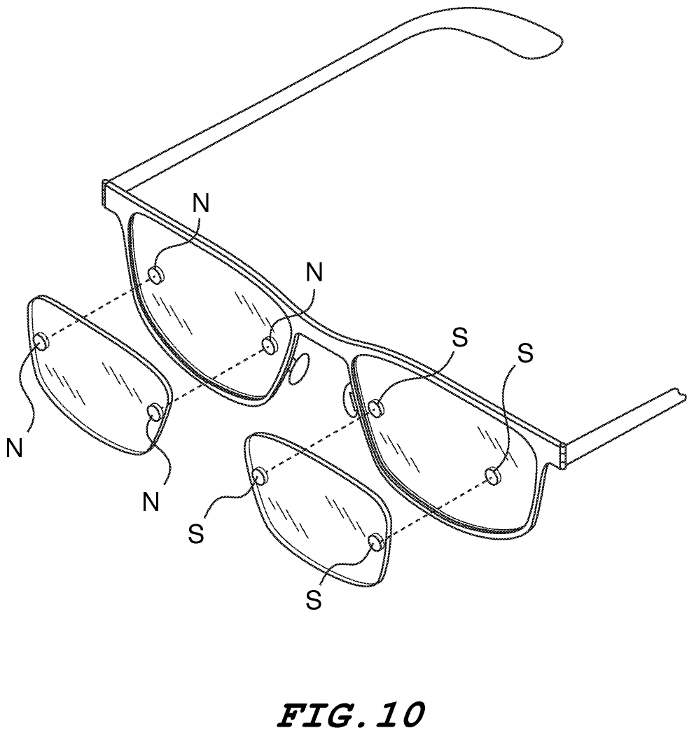

FIG. 10 is a drawing showing eyeglasses with two auxiliary lenses with magnets of opposite polarity, according to an embodiment.

Note the left lens of the eyeglass (“left” being to the left side of the page) has two magnets each with the north pole facing outward (away from the wearer). The left auxiliary lens which attaches onto the left eyeglass lens also has its two magnets with the north pole facing outward (away from the wearer and away from the eyeglass). Thus, the south pole of both magnets in the left auxiliary lens contact the north pole of both magnets in the left eyeglass lens, thereby causing an attractive force and keeping the left auxiliary lens connected (attached) to the left eyeglass lens. Similarly, the right lens of eyeglass has two magnets each with the south pole facing outward (away from the wearer). The right auxiliary lens which attaches onto the right eyeglass lens also has its two magnets with the south pole facing outward (away from the wearer and away from the eyeglass). Thus, the north pole of both agents in the right auxiliary lens contact the south pole of both magnets in the right eyeglass lens, thereby causing an attractive force and keeping the right auxiliary lens connected (attached) to the right eyeglass lens.

Thus, the left auxiliary lens is attracted to the left eyeglass lens but the left auxiliary lens would not be attracted to the right eyeglass lens due to the incompatibility of the polarities of magnets therein. Similarly, the right auxiliary lens is attracted to the right eyeglass lens but the right auxiliary lens would not be attracted to the left eyeglass lens due to the incompatibility of the polarities of the magnets therein. Note that the auxiliary lenses are curved and thus typically cannot be flipped over and still fit onto the respective eyeglass lens. For example, in FIG. 10, if left auxiliary lens were flipped over so that the north pole of both magnets in the left auxiliary lens were facing the eyeglass, then the curvature of the auxiliary lens would be such that it would not fit over the left (or right) eyeglass lens. The same goes for the right auxiliary lens. Thus, in this manner, by configuring the polarities of the magnets as shown, a user would not be able to use the left auxiliary lens on the right eyeglass lens and vice-versa because they would not be attracted to each other.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus, comprising:
a pair of eyeglasses comprises a first eyeglass lens and a second eyeglass lens, the first eyeglass lens comprises at least one embedded eyeglass lens magnet, wherein the second eyeglass lens does not have any embedded eyeglass lens magnets;
an auxiliary lens with at least one embedded auxiliary lens magnet, the at least one embedded auxiliary lens magnet configured to magnetically attach to the at least one embedded eyeglass lens magnet.

2. The apparatus as recited in claim 1, wherein the at least one embedded eyeglass lens magnet is two embedded eyeglass lens magnets, and the at least one embedded auxiliary lens magnet is two embedded auxiliary lens magnets.

3. The apparatus as recited in claim 1, wherein the at least one embedded eyeglass lens magnet is three embedded eyeglass lens magnets, and the at least one embedded auxiliary lens magnet is three embedded auxiliary lens magnets.

4. The apparatus as recited in claim 1, wherein each of the at least one embedded eyeglass lens magnets is a constant distance from an outer perimeter of its respective eyeglass lens.

5. The apparatus as recited in claim 4, wherein each of the at least one embedded auxiliary lens magnets is located a constant distance from an outer perimeter of its respective auxiliary lens.

6. An apparatus, comprising:
a pair of eyeglasses comprises a first eyeglass lens and a second eyeglass lens, the first eyeglass lens comprises at least one embedded left eyeglass lens magnet, and the second eyeglass lens comprises at least one embedded right eyeglass lens magnet;
a left auxiliary lens with at least one embedded left auxiliary lens magnet, the at least one embedded auxiliary lens magnet configured to magnetically attach to the at least one embedded left eyeglass lens magnet;
a right auxiliary lens with at least one embedded right auxiliary lens magnet, the at least one embedded auxiliary lens magnet configured to magnetically attach to the at least one embedded right eyeglass lens magnet,
wherein the at least one embedded left eyeglass lens magnet are all oriented such that its polarities are opposite to the at least one embedded right eyeglass lens magnet.

7. The apparatus as recited in claim 6, wherein the at least one embedded left eyeglass lens magnet is two magnets, and the at least one embedded right eyeglass lens magnet is two magnets, and the at least one embedded right auxiliary lens magnet is two magnets, and the at least one embedded left auxiliary lens magnet is two magnets.

8. The apparatus as recited in claim 6, wherein the at least one embedded left eyeglass lens magnet is three magnets, and the at least one embedded right eyeglass lens magnet is three magnets, and the at least one embedded right auxiliary lens magnet is three magnets, and the at least one embedded left auxiliary lens magnet is three magnets.

9. An apparatus, comprising:
a pair of eyeglasses comprising a left eyeglass lens and a right eyeglass lens, the left eyeglass lens comprising a first magnet and a second magnet, the right eyeglass lens comprising a third magnet and a fourth magnet;
a left auxiliary lens comprising a fifth magnet and sixth magnet, the left auxiliary lens configured such that the fifth magnet aligns over the first magnet and the sixth magnet aligns over the second magnet;
a right auxiliary lens comprising a seventh magnet and an eighth magnet, the right auxiliary lens configured such that the seventh magnet aligns over the third magnet and the eighth magnet aligns over the fourth magnet,
wherein the first magnet, the second magnet, the fifth magnet, and the sixth magnet, are all oriented with their particular poles in a first same direction;
wherein the third magnet, the fourth magnet, the seventh magnet, and the eighth magnet, are all oriented with their particular poles in a second same direction, the second same direction being opposite the first same direction.

10. The apparatus as recited in claim 9, wherein the first same direction is a north pole which faces away from a wearer of the pair of eyeglasses.

11. The apparatus as recited in claim 9, wherein the first same direction is a south pole which faces away from a wearer of the pair of eyeglasses.
